(19) United States
(12) Patent Application Publication
(10) Pub. No.: US 2011/0064928 A1
(43) Pub. Date: Mar. 17, 2011

(54) NONWOVEN MATERIAL

(75) Inventor: Achai Bonneh, Kochav Yair (IL)

(73) Assignee: AVGOL INDUSTRIES 1953 LTD, Tel Aviv (IL)

(21) Appl. No.: 12/990,969

(22) PCT Filed: May 5, 2009
(86) PCT No.: PCT/IL09/00464

§ 371 Date: Nov. 4, 2010

Related U.S. Application Data
(60) Provisional application No. 61/071,534, filed on May 5, 2008.

(51) Int. Cl. B32B 7/02

(52) U.S. Cl. 428/212

(57) ABSTRACT

Provided is a nonwoven material, including a spunbound layer including fibers having an average diameter between 12 and 25 microns, a meltblown layer adjacent to the spunbound layer and including fibers having an average diameter between 2 and 5 microns, and an electrospun layer adjacent to the meltblown layer and including nanofibers having an average diameter between 100 and 400 nanometers. Also provided is an electrospun layer having a basis weight of at least 0.2 gsm, the total basis weight of the meltblown layer is at least twice that of the electrospun layer, and the total basis weight of all of the meltblown layers in the material constitutes at least 3% of the basis weight of the material. Further provided is a spunbound layer that may have an average pore size between 70 and 120 microns, the meltblown layer may have an average pore size between 15 and 25 microns, and the electrospun layer may have an average pore size between 500 nanometers and 2 microns.

### FIELD OF THE INVENTION

This invention relates to a non-woven material.

### BACKGROUND OF THE INVENTION

Non-woven materials or textiles are a type of fabric-like material which is typically manufactured by mechanically or thermally binding fibers, either from natural fibers or manmade materials.

One example of a non-woven material is a multi-layer material comprising several layers, each of which may be manufactured using either a spunbond or meltblown process. In the spunbond process, raw material is extruded into a thin fiber (on the order of several microns), and the extruded fiber is randomly deposited on a conveyor belt. In the meltblown process, fibers are extruded and then blown onto another layer or directly onto a conveyor belt. The layers are then mechanically or thermally bonded, i.e., via heat bonding or hydro-entanglement. In addition, additives, either to the materials themselves or in the form of topical treatments, such as surfactants, antistatic, impregnations, fluorocarbons, fire-resistant additives, etc., may be provided. It is well known that the parameters used in each step of the manufacture affect properties of the final material.

In addition, it is known to form non-woven materials from nanofibers produced by electro-spinning (electrostatic spinning) For example, US 2006/0290031 discloses a method of nanofibers production from a polymer solution using electrostatic spinning in an electric field created by a potential difference between a charged electrode and a counter electrode. The polymer solution is for spinning supplied into the electric field using the surface of the rotating charged electrode, while on a part of the circumference of the charged electrode near to the counter electrode is a spinning surface created, by which a high spinning capacity is reached. Further the invention relates to a device for carrying out the method, where the charged electrode is pivoted and by its (bottom) part of its circumference it is immersed in the polymer solution, while against the free part of the circumference of the charged electrode is positioned the counter electrode.

WO 2008/011840 discloses a collecting electrode of a device for production of nanofibers through electrostatic spinning of polymer solutions, which contains a conductive thin-walled body of electrode, in which there is performed at least one opening, on whose circumference there is arranged the border, while in the inner space of the body of electrode there is mounted at least one holder of electrode connected with at least one brace fastened in the spinning chamber, while the holder of electrode is arranged behind border of the opening.

WO 2008/028428 discloses a rotary spinning electrode of an elongated shape into the device for production of nanofibers through electrostatic spinning of polymer solutions comprising a pair of end faces, between them there are positioned spinning members formed by wire, which are distributed equally along the circumference and parallel with axis of rotation of the rotary spinning electrode, while the end faces are made of electrically non-conducting material and all the spinning members are mutually connected in a electrically conductive manner.

WO 2007/137530 discloses a device for production of nanofibers through electrostatic spinning of polymer solutions comprising a spinning chamber, in which the reservoir of polymer solution is positioned, into which by a section of its circumference extends the rotating spinning electrode of elongated shape connected to one pole of high voltage source of direct current, to whose opposite pole there is connected the collecting electrode arranged in the spinning chamber against the spinning electrode, while a section of circumference of the spinning electrode extends into a polymer solution in the reservoir while the reservoir of polymer solution is divided into the inlet section, into which leads at least one inlet opening, and into which the spinning electrode extends by a section of its circumference, and the outlet section, which is provided with outlet opening.

WO 2006/108364 discloses a textile containing at least one layer of polymeric nanofibers having diameter to 600 nanometers produced through electrostatic spinning of the polymer solution. The polymeric nanofibers contain particles of low-molecular substance dissolved or dispersed in solution of polymer which is subject to electrostatic spinning, possibly particles of low molecular substance which was created through a consequent chemical reaction of the original low molecular substance dissolved or dispersed in solution subjected to electrostatic spinning. The invention also relates to the production method of the layer of nanofibers from the polymer solution through electrostatic spinning in electric field created by difference of potentials between the charged electrode and the counter-electrode, at which the solution of polymer is brought into the electric field for spinning through the surface of the rotating charged electrode, at the same time the nanofibers created in this electric field are carried to the counter-electrode and they deposit on the surface designated to it. Polymer solution for spinning contains the particles of low-molecular substance, which are at spinning seized together with polymer into the nanofibers being created.

### SUMMARY OF THE INVENTION

According to one aspect of the present invention, there is provided a nonwoven material comprising:
a spunbond layer comprising fibers having an average diameter between 12 and 25 microns;
a meltblown layer adjacent to the spunbond layer and comprising fibers having an average diameter between 2 and 5 microns; and
an electrospun layer adjacent to the meltblown layer and comprising nanofibers having an average diameter between 100 and 400 nanometers;
   wherein the electrospun layer has a basis weight of at least 0.2 gsm, the total basis weight of the meltblown layer being at least twice that of the electrospun layer, and the total basis weight of all of the meltblown layers in the material constituting at least 3% of the basis weight of the material. These features, inter alia, provide the material with the necessary operating parameters, e.g., in connection with filtration ability, breathability, basis weight, etc.

The spunbond layer may comprise fibers having an average diameter between 12 and 20 microns.

In addition, the nonwoven material may be provided such that:
the spunbond layer has an average pore size between 70 and 120 microns;
the meltblown layer has an average pore size between 15 and 25 microns; and
the electrospun layer has an average pore size between 500 nanometers and 2 microns.

The average pore size of the spunbond layer may be between 2.8 and 8 times that of the adjacent meltblown layer.

The average pore size of the meltblown layer may be between 7.5 and 50 times that of the adjacent electrospun layer.

The average diameter of the fibers of the spunbond layer may be between 2.4 and 10 times that of the fibers of the meltblown layer.

The average diameter of the fibers of the meltblown layer may be between 5 and 50 times that of the fibers of the electrospun layer.

The layers may be intermittently bonded to one another.

The spunbond layer may be made from a material selected from the group comprising polyester, PLA, polyolefin, polypropylene, and polyethylene.

The meltblown layer may be made from a material selected from the group comprising polyester, polyolefin, polypropylene, polyurethane, latex, elastic adhesive, elastomeric polyethylene, and elastomeric polypropylene.

The electrospun layer may be made from a material selected from the group comprising PVA, PVA C, PA 6, PA 6/12, PA 12, PAA, PAN, PEOX, PESO, PS, PUR, PVP, PVP, polyolefin, polypropylene, and polyethylene.

According to another aspect of the present invention, there is provided a nonwoven material comprising:
a spunbond layer having an average pore size between 70 and 120 microns;
a meltblown layer adjacent to the spunbond layer and having an average pore size between 15 and 25 microns; and
an electrospun layer adjacent to the meltblown layer and having an average pore size between 500 nanometers and 2 microns;
   wherein the electrospun layer has a basis weight of at least 0.2 gsm, the total basis weight of the meltblown layer being at least twice that of the electrospun layer, and the total basis weight of all of the meltblown layers in the material constituting at least 3% of the basis weight of the material.

In addition, the nonwoven material may be provided such that:
the spunbond layer comprises fibers having an average diameter between 12 and 25 microns;
the meltblown layer comprises fibers having an average diameter between 2 and 5 microns; and
the electrospun layer comprises nanofibers having an average diameter between 100 and 400 nanometers.

The spunbond layer may comprise fibers having an average diameter between 12 and 20 microns. The average pore size of the spunbond layer may be between 2.8 and 8 times that of the adjacent meltblown layer.

The average pore size of the meltblown layer may be between 7.5 and 50 times that of the adjacent electrospun layer.

The average diameter of the fibers of the spunbond layer may be between 2.4 and 10 times that of the fibers of the meltblown layer.

The average diameter of the fibers of the meltblown layer may be between 5 and 50 times that of the fibers of the electrospun layer.

The layers may be intermittently bonded to one another.

The spunbond layer may be made from a material selected from the group comprising polyester, PLA, polyolefin, polypropylene, and polyethylene.

The meltblown layer may be made from a material selected from the group comprising polyester, polyolefin, polypropylene, polyurethane, latex, elastic adhesive, elastomeric polyethylene, and elastomeric polypropylene.

The electrospun layer may be made from a material selected from the group comprising PVA, PVA C, PA 6, PA 6/12, PA 12, PAA, PAN, PEOX, PESO, PS, PUR, PVP, PVP, polyolefin, polypropylene, and polyethylene.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIGS. 1A through 1C are schematic cross-sectional views of non-woven materials.

### DETAILED DESCRIPTION OF EMBODIMENTS

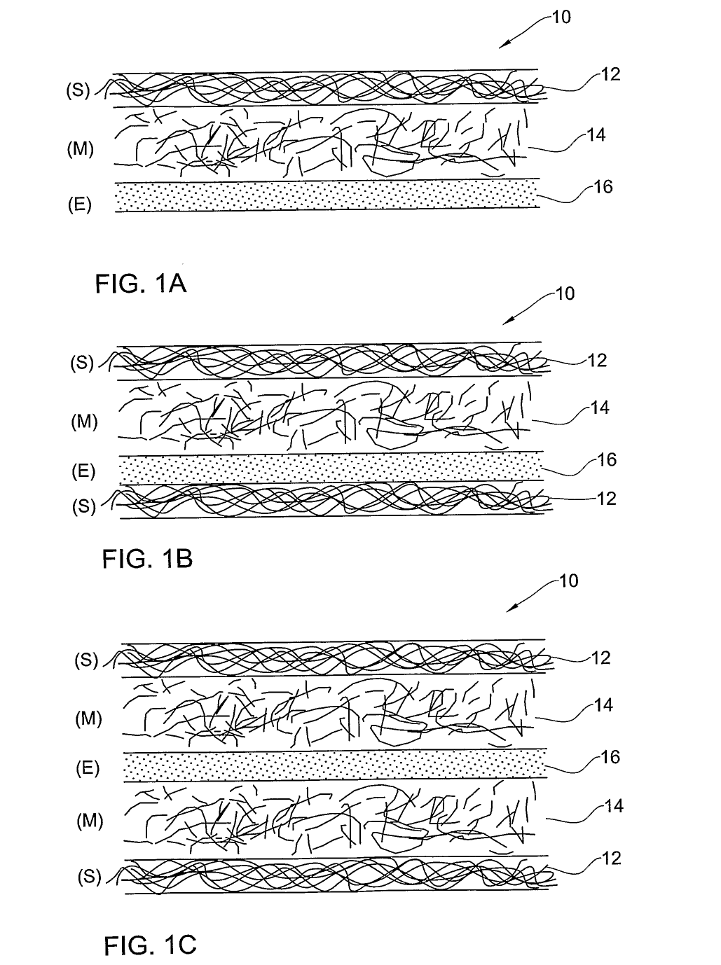

As illustrated in FIG. 1A through 1C, a non-woven material, which is generally indicated at 10, is provided. The material 10 comprises at least three layers: a spunbond layer (S) 12, a meltblown layer (M) 14, and a solvent- or water-based electrospun, or melt electrospun (E, hereafter collectively referred to as electrospun) layer 16 of nanofibers.

It will be appreciated that the term “layer” when used herein refers to both distinct layers, i.e., a layer which is formed as a single stratum, as well as to multiple similar strata which are formed or disposed one atop another, e.g., multiple layers of the same type (i.e., spunbond, meltblown, or electrospun) which are formed one atop another may be considered as a single layer of that type.

Reverting to FIG. 1A, there is illustrated a material 10, comprising a spunbond layer 12, a meltblown layer 14, and an electrospun layer 16. Such a material is typically indicated as SME.

FIG. 1B illustrates another example of the material 10, comprising a first spunbond layer 12, a meltblown layer 14, an electrospun layer 16, and a second spunbond layer 12. Such a material is typically indicated as SMES.

FIG. 1C illustrates a further example of the material 10, being symmetric, and comprising a first spunbond layer 12, a first meltblown layer 14, an electrospun layer 16, a second meltblown layer 14, and a second spunbond layer 12. Such a material is typically indicated as SMEMS.

It will be appreciated that the examples illustrated in FIGS. 1A through 1C are not limiting, and a material may contain any combination of layers without departing from the spirit and scope of the invention, provided that the material contains at least three layers, one each of S, M, and E, in that order.

According to any one of the above examples, the layers may be intermittently bonded to one another, for example to form a pattern on faces of the material 10.

The spunbond layer 12 may comprise fibers having an average diameter in a range between 12 and 25 microns, or more particularly, in a range between 12 and 20 microns. The average fiber diameter of the spunbond layer 12 may be between 2.4 and 10 times that of the meltblown layer 14. The average pore size of the spunbond layer 12 may be between 70 and 120 microns. The average pore size of the spunbond layer 12 may be between 2.8 and 8 times that of the meltblown layer 14.

The meltblown layer 14 may comprise fibers having an average diameter in a range between 2 and 5 microns. The average fiber diameter of the meltblown layer 14 may be between 5 and 50 times that of the electrospun layer 16. The average pore size of the meltblown layer 14 may be between 15 and 25 microns. The average pore size of the meltblown layer 14 may be between 7.5 and 50 times that of the electrospun layer 16.

The electrospun layer 16 may comprise nanofibers having an average diameter in a range between 100 and 400 nanometers (0.1 and 0.4 microns). The average pore size of the electrospun layer 16 may be between 15 and 25 microns. The average pore size of the electrospun layer 16 may be between 500 and 2,000 nanometer (0.5 and 2 microns).

The basis weight of the electrospun layer 16 is at least 0.2 g/m² (gsm). The basis weight of the meltblown layer 14 is at least twice that of the electrospun layer 16. In addition, the weight of the meltblown layer 14 is at least 3% of that of the entire material.

The spunbond layer 12 may be formed in any known way, for example from a continuous fiber, having been forced through an extruder having spinnerets with capillary diameters that range between approximately 0.35 and 0.8 mm and a hole density ranges between approximately 2000 and 8000 holes/m. It may be made from any suitable material, including, but not limited to, polyester grades including PLA, polyolefin, polypropylene, or polyethylene.

The meltblown layer 14 may be formed in any known way, for example from fibers having been extruded through spinnerets with capillary diameters that range between approximately 0.2 and 0.5 mm and a hole density ranges between approximately 15 and 50 holes/in. A hot air stream may be used to draw the extruded polymer into fine fibers, thus forming the meltblown layer. The meltblown layer 14 may be made of any appropriate material, including, but not limited to, polyester, polyolefin, polypropylene, polyurethane, latex, elastic adhesive, elastomeric polyethylene, or elastomeric polypropylene.

The electrospun (E) layer may be made in any known way, and may be made from PVA, PVA C, PA 6, PA 6/12, PA 12, PAA, PAN, PEOX, PESO, PS, PUR, PVP, PVP, a polyolefin, polypropylene, or polyethylene.

Any one or more of the layers 12, 14, 16 may be made as a bi-component fiber of two or more materials listed above, or any other appropriate material.

The layers may be formed directly on the adjacent layers (e.g., in the example illustrated in and described with reference to FIG. 1A, the meltblown layer 14 may be formed directly on its adjacent spunbond layer 12, and the electrospun layer 16 may be formed directly on the meltblown layer), after which the layers are bonded to one another. Alternatively, each layer may be formed independently, and then unwound in the appropriate sequence (e.g., in the example illustrated in and described with reference to FIG. 1A, the layers are arranged such that the meltblown layer 14 is between the spunbond layer 12 and the electrospun layer 16),), after which the layers are bonded to one another.

The gradient of the pore sizes across the material 10 allows for a high degree of filtering with a reduced pressure drop between adjacent layers. It will be appreciated that, when the spunbond layer faces the medium to be filtered (for example, if used in an air filter whose intended function is to filter air before it reaches the user, the spunbond layer 12 would typically be facing away from the user), such an arrangement increases the breathability of the material without forgoing the high level of filtration afforded by the electrospun layer 16.

The material according to any of the examples given above, as well as according to any example which is within the scope of the invention, has several advantages over a similarly formed material which lacks an electrospun layer. For example, it exhibits a high score in “hydro-head” tests (a test which aims to measure water resistance), lower pore size and narrower pore distribution, and a lower pressure drop across the material for gases traversing its thickness.

Such a material may be useful, inter alia, in the following applications:
it may be used in diaper liners or other diaper components, due, e.g., to its low weight, high weight, high breathability, fluid-resistance properties, and ability to contain fine solid particles;
it may be used in medical garments and masks, due, e.g., to its low pore size, which makes it a bacterial barrier, its low weight, its breathability, and its fluid-resistance properties; and
it may be useful for manufacture of high efficiency/low pressure drop filter media. The low pressure drop experienced across its surface and small pore size make it suitable for use is manufacture of HEPA (high efficiency particulate air) and/or ULPA (ultra low penetration air) filters.

It will be clear that the material 10 may further be used in applications other than the above without departing from the spirit and the scope of the present invention.

Those skilled in the art to which this invention pertains will readily appreciate that numerous changes, variations and modifications can be made without departing from the scope of the invention mutatis mutandis.

1.-22. (canceled)

23. A nonwoven material, comprising:
a spunbound layer comprising fibers having an average diameter between 12 and 25 microns;
a meltblown layer adjacent to the spunbound layer and comprising fibers having an average diameter between 2 and 5 microns; and
an electrospun layer adjacent to the meltblown layer and comprising nanofibers having an average diameter between 100 and 400 nanometers;
wherein the electrospun layer has a basis weight of at least 0.2 gsm, the total basis weight of the meltblown layer being at least twice that of the electrospun layer, and the total basis weight of all of the meltblown layers in the material constituting at least 3% of the basis weight of the material.

24. The nonwoven material according to claim 23, wherein the spunbound layer comprises fibers having an average diameter between 12 and 20 microns.

25. The nonwoven material according to claim 23, wherein:
the spunbound layer has an average pore size between 70 and 120 microns;
the meltblown layer has an average pore size between 15 and 25 microns; and
the electrospun layer has an average pore size between 500 nanometers and 2 microns.

26. The nonwoven material according to claim 23, wherein the average pore size of the spunbound layer is between 2.8 and 8 times that of the adjacent meltblown layer.

27. The nonwoven material according to claim 23, wherein the average pore size of the meltblown layer is between 7.5 and 50 times that of the adjacent electrospun layer.

28. The nonwoven material according to claim 23, wherein the average diameter of the fibers of the spunbound layer is between 2.4 and 10 times that of the fibers of the meltblown layer.

29. The nonwoven material according to claim 23, wherein the average diameter of the fibers of the meltblown layer is between 5 and 50 times that of the fibers of the electrospun layer.

30. The nonwoven material according to claim 23, wherein the layers are intermittently bonded to one another.

31. The nonwoven material according to claim 23, wherein the spunbound layer is made from a material selected from the group consisting of polyester, PLA, polyolefin, polypropylene, and polyethylene.

32. The nonwoven material according to claim 23, wherein the meltblown layer is made from a material selected from the group consisting of polyester, polyolefin, polypropylene, polyurethane, latex, elastic adhesive, elastomeric polyethylene, and elastomeric polypropylene.

33. The nonwoven material according to claim 23, wherein the electrospun layer is made from a material selected from the group consisting of PVA, PVA C, PA 6, PA 6/12, PA 12, PAA, PAN, PEOX, PESO, PS, PUR, PVP, polyolefin, polypropylene, and polyethylene.

34. A nonwoven material, comprising:
a spunbound layer having an average pore size between 70 and 120 microns;
a meltblown layer adjacent to the spunbound layer and having an average pore size between 15 and 25 microns; and
an electrospun layer adjacent to the meltblown layer and having an average pore size between 500 nanometers and 2 microns;
wherein the electrospun layer has a basis weight of at least 0.2 gsm, the total basis weight of the meltblown layer being at least twice that of the electrospun layer, and the total basis weight of all of the meltblown layers in the material constituting at least 3% of the basis weight of the material.

35. The nonwoven material according to claim 34, wherein:
the spunbound layer comprises fibers having an average diameter between 12 and 25 microns;
the meltblown layer comprises fibers having an average diameter between 2 and 5 microns; and
the electrospun layer comprises nanofibers having an average diameter between 100 and 400 nanometers.

36. The nonwoven material according to claim 35, wherein the spunbound layer comprises fibers having an average diameter between 12 and 20 microns.

37. The nonwoven material according to claim 34, wherein the pore size of the spunbound layer is between 2.8 and 8 times that of the adjacent meltblown layer.

38. The nonwoven material according to claim 34, wherein the average pore size of the meltblown layer is between 7.5 and 50 times that of the adjacent electrospun layer.

39. The nonwoven material according to claim 34, wherein the average diameter of the fibers of the spunbound layer is between 2.4 and 10 times that of the fibers of the meltblown layer.

40. The nonwoven material according to claim 34, wherein the average diameter of the fibers of the meltblown layer is between 5 and 50 times that of the fibers of the electrospun layer.

41. The nonwoven material according to claim 34, wherein the layers are intermittently bonded to one another.

42. The nonwoven material according to claim 34, wherein the spunbound layer is made from a material selected from the group consisting of polyester, PLA, polyolefin, polypropylene, and polyethylene.

43. The nonwoven material according to claim 34, wherein the meltblown layer is made from a material selected from the group consisting of polyester, polyolefin, polypropylene, polyurethane, latex, elastic adhesive, elastomeric polyethylene, and elastomeric polypropylene.

44. The nonwoven material according to claim 34, wherein the electrospun layer is made from a material selected from the group consisting of PVA, PVA C, PA 6, PA 6/12, PA 12, PAA, PAN, PEOX, PESO, PS, PUR, PVP, polyolefin, polypropylene, and polyethylene.
